(19) United States
(12) Patent Application Publication
(10) Pub. No.: US 2008/0128474 A1
(43) Pub. Date: Jun. 5, 2008

(54) Solder Foil for Soldering Parts, Particularly Plates of Heat Exchangers

(75) Inventor: Herbert Damsohn, Aichwald (DE)

Correspondence Address: FOLEY AND LARDNER LLP;SUITE 500, 3000 K STREET NW, WASHINGTON, DC, 20007, US

(73) Assignee: BEHR GmbH & CO. KG, Stuttgart (DE)

(21) Appl. No.: 10/592,584

(22) PCT Filed: Mar. 3, 2005
(86) PCT No.: PCT/EP05/02236

§ 371 Date: Oct. 15, 2007

(30) Foreign Application Priority Data
Mar. 18, 2004 (DE) 10 2004 013 688.2

(51) Int. Cl. B23K 31/02; B23K 35/14

(52) U.S. Cl. 228/185; 228/56.3

(57) ABSTRACT

The invention relates to a solder film for soldering parts, particularly plates of heat exchangers. To this end, the solder foil has a defined contour adapted to the parts to be soldered. According to the invention, the solder foil (12) can be produced as a part of a strip (11) of individual foils (12) connected to one another by material bridges (13).

The invention relates to a solder foil for soldering parts, particularly plates of heat exchangers, according to the precharacterizing part of patent claim 1.

In the production of soldered joints between two parts, the solder has to be deposited prior to the soldering process in the gap in a precisely metered amount. During the soldering process at a temperature above the melting point of the solder material, the solder is melted and fills the gap. The solder can be deposited in different forms, for example as solder paste, in the form of solder granules or as solder foil which is used in particular in the case of solder surfaces of planar design. The material of the solder foil is matched to the material of the parts to be soldered, for example, copper or nickel solders are used in the soldering of stainless steel parts. A solder foil of this type has been disclosed by DE-C 20 61 825 of the applicant, to be precise for the soldering of cooling elements of a plate heat exchanger, the cooling elements being designed as pairs of disks with turbulence plates enclosed. The solder foil is matched in its contour to the disks and is inserted in each case between a disk and a turbulence plate.

A further example of using solder foils has been disclosed by DE 103 28 274 A1 of the applicant, to be precise in the production of a stacked heat exchanger, in which a multiplicity of layers, comprising individual plates, are to be soldered to one another. The solder foils are layered in alternating fashion with the plates of the heat exchanger to form a stack, are fixed in place and are soldered in a soldering furnace.

A disadvantage of the use of solder foils of the known type is that they can be difficult to handle during the manufacturing process, i.e. can be grasped or gripped. The production of the solder foils by punching causes the formation on the interfaces of a burr which leads to solder foils resting on one another becoming interlocked and making it more difficult to separate them. This may have the consequence that, when stacking a block of layers, instead of one solder foil, two or more solder foils lie on one another, which may lead to an increased provision of solder during the soldering process and therefore to a “failure” of the plates, i.e. to a defective soldering or to brittle phases in the gap. Furthermore, during the stacking of plates and solder foils, one or more solder foils may be forgotten, which has the consequence of soldering not taking place, i.e. of the part likewise being rejected.

It is the object of the present invention to provide a solder foil of the type mentioned at the beginning which can be handled more simply and reliably in the manufacturing process, in particular in the preparation for the soldering process of the parts to be soldered. In particular, it is also the object of the invention to improve, with regard to the soldered joint, the method of producing soldered plate heat exchangers.

This object is achieved by the features of patent claim 1. According to the invention, it is provided that the solder foil can be produced as part of a strip which comprises a chain of individual foils connected to one another by material bridges. The solder foil with a certain contour for a certain soldered joint is therefore not provided individually but rather as a cohesive strip from which an individual foil can be severed in each case. The material bridges are preferably therefore designed as predetermined breaking points, so that the individual foils can be torn off. This obviates the problem of separating the solder foils, as described above with regard to the prior art. The strip with the individual foils which can be torn off can be held ready in a solder-foil dispenser in various forms, for example as a wound-up coil or as a strip folded in zig-zag fashion, with the tear-off edges forming the buckling points.

In an advantageous refinement of the invention, the strip with the individual foils is wound up to form a coil. This affords the advantage of a space-saving provision of solder foils for the manufacturing process and the possibility of tearing off the individual solder foils by hand or mechanically. It is therefore ensured that only one solder foil is removed in each case and applied to the stack. As a result, the soldering quality is improved.

In a further advantageous refinement of the invention, the material bridges between the individual foils are designed as webs which preferably have constrictions for forming the predetermined breaking points. The solder foil strip according to the invention is preferably produced by punching it out of a strip-shaped solder foil. A burr produced, for example, by the punching is harmless in the solder foil present as a strip, i.e. it cannot lead to interlocking as in the prior art.

In an advantageous refinement of the invention, the material bridges or webs can be designed as indicating flags which remain after an individual foil has been torn off, and protrude over the outer contour of the individual foil. When individual plates of a heat exchanger are stacked, the protruding indicating flags serve as a visual check to see whether the stack has been fully equipped with solder foils.

According to an advantageous development of the invention, the contour of an individual foil is rectangular or square. This results in a particularly simple blank for punching. However, other shapes which can be arranged in a row next to one another by means of suitable material bridges as links of a chain are also possible—for example, oval shapes.

According to an advantageous development of the invention, the solder foil which can be torn off can be used in particular in the production of plate heat exchangers or stacked heat exchangers. The stack can be completed rapidly and reliably, with mechanical supplying of the solder foil which can be torn off also being possible, i.e. automatic manufacturing. The solder foil according to the invention is therefore particularly advantageous when using robots to produce stacked heat exchangers.

An exemplary embodiment of the invention is illustrated in the drawing and is described in more detail below. In the drawing

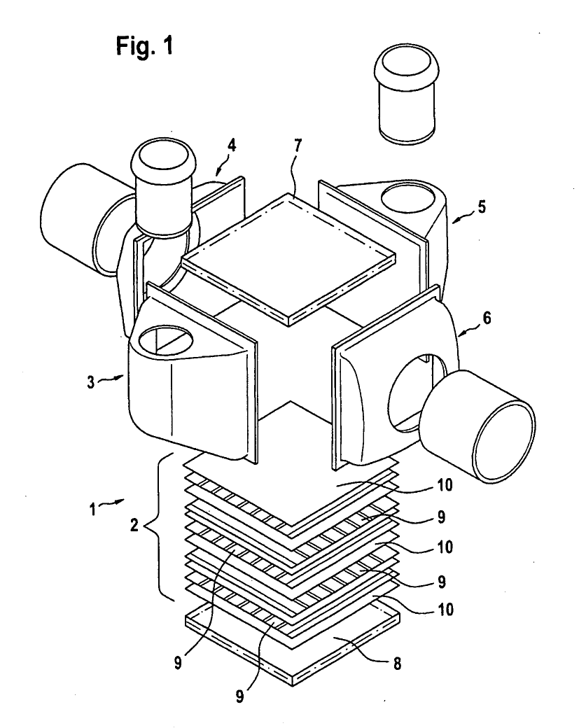

FIG. 1 shows a stacked heat exchanger in an exploded illustration before assembly,

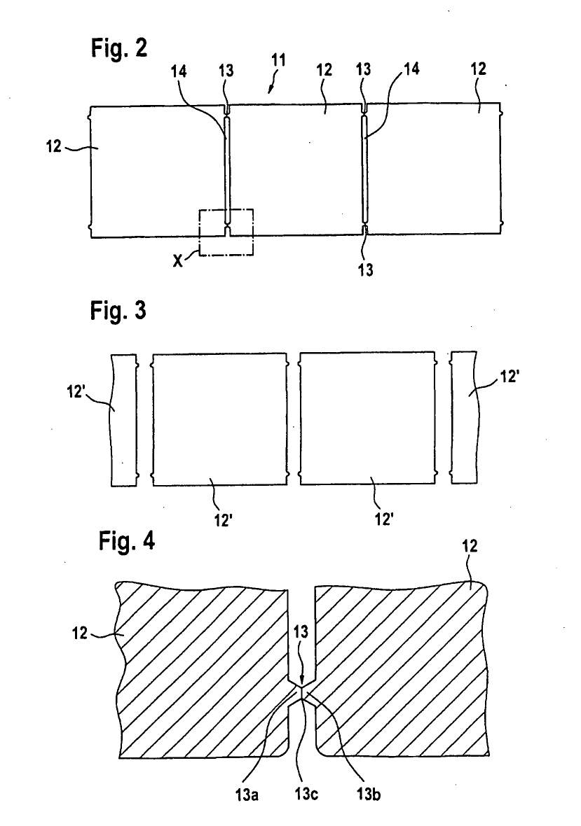

FIG. 2 shows a strip according to the invention of solder foils,

FIG. 3 shows the strip according to FIG. 2, but with separated individual foils, and

FIG. 4 shows a connecting web between two individual foils as detail X.

FIG. 1 shows a stacked heat exchanger 1, as is essentially known from the prior art mentioned at the beginning, i.e. DE 103 28 274 A1, which is incorporated in its entirety into the content of disclosure of this application. The stacked heat exchanger 1, which is shown in an exploded illustration, is essentially composed of a stack 2 and four connecting boxes 3, 4, 5, 6 and two cover plates 7, 8, an upper and a lower cover plate. The stack 2 is constructed from profiled separating plates 9, which are arranged in an alternating fashion rotated through 90° and solder foils 10. The complete production process including stacking, soldering and welding of the individual parts of the stacked heat exchanger 1 is described in the prior art mentioned and is therefore not explained here, but rather reference is made to DE 103 28 274 A1.

FIG. 2 shows a strip 11 according to the invention, comprising individual solder foils which are connected to one another and are of square design, what are referred to as individual foils 12, of which here, for example, three individual foils 12 of an endless strip 11 are illustrated. The individual foils 12 are connected in each case via metal bridges in the form of two thin webs 13 between which a respective gap 14 is left. The endless strip 11 is wound up—which is not illustrated here—to form a coil and is mounted rotatably in a matching, for example, drum-shaped dispenser (likewise not illustrated), so that individual foils can be severed from the end of the coil.

FIG. 3 shows individual foils 12′ which are separated from one another, which preferably takes place by individual foils 12′ being torn off. The tearing off can take place manually or mechanically, the latter during automatic manufacturing.

FIG. 4 shows a detail X from FIG. 2, i.e. a cutout of two adjacent individual foils 12 with the web 13 which connects the two individual foils 12. The web 13 comprises two trapezoidal halves 13a, 13b which butt against each other in the region of their short sides and form a constriction 13c. The pulling apart of adjacent individual foils 12 causes a tearing of the web 13 in the region of the constriction, i.e. the constriction 13c forms a predetermined breaking point. This results in a defined tearing-off edge when tearing off the individual foils 12, with the result that the web halves 13a and 13b, which are of trapezoidal design, remain on the torn-off individual foils—these form “indicating flags”. When building up the layers of a stack 2—as illustrated in FIG. 1—the solder foils 10 shown there would be replaced by the solder foils 12′ according to the invention, i.e. each solder foil would be immediately visible or else automatically recognizable as a consequence of the protruding “indicating flags” 13a, 13b. This constitutes an important checking measure during manufacturing. The finished stack can therefore easily be checked to see whether it is complete with regard to the number of solder foils.

The abovementioned endless strip 11 can be produced as follows: first of all, a continuous strip (semi-finished product) of solder-foil material, for example of copper or a nickel alloy, is provided in the form of a coil and is supplied to a punching device (not illustrated). The latter produces the gaps 14 and webs 13, which are illustrated in FIG. 2, by punching out thin strips of material. The punched strip 11 is subsequently wound up again to form a coil which can then be used for the process of manufacturing a stacked heat exchanger, i.e. the construction of a stack of separating plates and solder foils.

1. A solder foil for soldering parts, particularly plates of heat exchangers, the solder foil having a contour matched to the parts to be soldered, wherein the solder foil can be produced as part of a strip of individual foils connected to one another by material bridges.

2. The solder foil as claimed in claim 1, wherein the material bridges are designed as predetermined breaking points.

3. The solder foil as claimed in claim 1, wherein the individual foils can be severed, in particular torn off, individually from the strip.

4. The solder foil as claimed in claim 1, wherein the strip can be wound up to form a coil.

5. The solder foil as claimed in claim 1, wherein the material bridges are designed as webs, and in that gaps are left between the webs.

6. The solder foil as claimed in claim 1, wherein the individual foils can be produced together with the material bridges by punching from a strip of semi-finished product.

7. The solder foil as claimed in claim 5, wherein the material bridges have a constriction.

8. The solder foil as claimed in claim 1, wherein the material bridges or webs are designed as indicating flags which, after the individual foils are torn off, protrude over the contour thereof.

9. The solder foil as claimed in claim 1, wherein the contour of the individual foils is of rectangular or square design.

10. A method for producing a soldered plate heat exchanger using the solder foil as claimed in claim 1, comprising
supplying a strip of interconnected solder foils;
stacking a plurality of plate members suitable for forming a stacked heat exchanger;
separating individual solder foils from the strip and interleaving a solder foil between each pair of plates; and
soldering the plates together.
